(19) United States
(12) Patent Application Publication
(10) Pub. No.: US 2008/0143608 A1
(43) Pub. Date: Jun. 19, 2008

(54) ANTENNA-INTEGRATED MODULE

(75) Inventors: Hirokazu WATANABE, Fukushima-ken (JP); Tomotaka SUZUKI, Fukushima-ken (JP); Atsushi MURATA, Fukushima-ken (JP); Yoshikiyo WATANABE, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD., Tokyo (JP)

(21) Appl. No.: 11/944,278

(22) Filed: Nov. 21, 2007

(30) Foreign Application Priority Data
Dec. 13, 2006 (JP) 2006-335856

(51) Int. Cl. H01Q 1/38

(52) U.S. Cl. 343/700 MS

(57) ABSTRACT

The present invention provides an antenna-integrated module capable of decreasing the size thereof, facilitating prevention of arbitrary alternation to the circuit, effectively performing a reflow process, and being manufactured at low cost. Circuit elements 3 are mounted on a circuit board 1 with a wiring pattern and a ground conductive layer 2 and a sheet-metal covering antenna element 4 mounted on the circuit board 1 covers the circuit elements 3. The covering antenna element 4 includes a rectangular top plate 5 with openings 5a, a power feeding leg piece 6 connected to a feeding line of the wiring pattern, short-circuited leg pieces 7 and 8 connected to the ground conductive layer 2, support leg pieces 9 to 11 electrically opened, side plates 12 to 15 with openings 12a to 15a and the pieces 6 to 11 are soldered on the circuit board 1.

### BACKGROUND OF THE INVENTION

1. Field of the Invention

The present invention relates to an antenna-integrated module suitable for a small-sized transceiver used for communication or broadcasting.

2. Description of the Related Art

In recent years, as wireless communication techniques have been developed, various electronic apparatuses or wireless cards in which small-sized transceiver units are mounted have been proposed. This type of each transceiver unit is an antenna-integrated high frequency module in which an antenna element is mounted on a circuit board with a high frequency circuit. In the known antenna-integrated module, a sheet-metal shield case covers a predetermined region of the circuit board on which the main elements of the high frequency circuit are mounted. An antenna element such as a chip antenna or a pattern antenna is mounted on other regions of the circuit board (for example, see JP-A-2002-232221 (pages 4 to 6 and FIG. 1)).

However, in a structure in which the antenna element and the shield case are disposed on the other regions of the circuit board in this manner, the size of the entire module increases in plan view. Therefore, a problem arises in that it is difficult to decrease the size thereof. Moreover, if a configuration in which the chip antenna is used as the antenna element and connected to the high frequency circuit through a coaxial cable is used, a problem also arises in that element cost considerably increases.

In order to solve such problems, there has recently proposed an antenna-integrated module in which a shield case for electrically shielding circuit elements of a high frequency circuit also serves as an antenna element of an inverted F-type antenna (for example, see JP-A-2005-5866 (pages 4 and 5 and FIG. 1)). In the proposed example, there is used a sheet-metal covering antenna element including a plurality of bent leg pieces extend from the periphery of a rectangular top plate (flat metal plate). The covering antenna element is mounted on a circuit board with a high frequency circuit. In addition, a predetermined bent leg piece is connected to a wiring pattern of the high frequency circuit or a ground conductive layer so as to serve as a feeding pin or a short-circuited pin and the remaining bent leg pieces are also connected to an electrically isolated soldering land. The top plate stably supported by the bent leg pieces is disposed so as to be opposite the circuit board at a predetermined interval at a position where the top plate covers the circuit elements of the high frequency circuit. Therefore, the top plate connected to the bent leg piece corresponding to the short-circuited pin can electrically shield the circuit elements of the high frequency circuit. Since the top plate is connected to the bent leg piece corresponding to the feeding pin, the top plate can serve as a radiation conductor of an inverted F-type antenna. When the sheet-metal covering antenna element is used, it is possible to realize antenna-integrated module that can be easily miniaturized and manufactured at low cost, compared with the known technique in which a special antenna element and a shield case are disposed in line in plan view.

As described above, the known antenna-integrated module disclosed in JP-A-2005-5866 (pages 4 and 5 and FIG. 1), the covering antenna element is used to decrease the size thereof and manufacture it at low cost. However, in the covering antenna element, the top plate formed of the metal plate is disposed at a position where the top plate covers the circuit elements. Accordingly, when a reflow soldering process of the circuit elements mounted on the circuit board and a reflow soldering process of the covering antenna element are performed together, heat cannot be sufficiently delivered from a reflow furnace to a region covered with the top plate. Therefore, the soldering connection of the circuit elements may deteriorate. In this way, in the antenna-integrated module, after the circuit elements are mounted on the circuit board, and then a first reflow soldering process is performed, the covering antenna element is mounted on the circuit board, and then the reflow soldering process has to be performed again at lower melting temperature than the temperature in the first reflow soldering process. Therefore, a problem arises in that the reflow process cannot be effectively performed.

Moreover, in the covering antenna element of such a known antenna-integrated module, a plurality of the bent leg pieces just extend from the periphery of the top plate, and thus a space (region on which circuit elements are mounted) covered with the top plate is considerably exposed in side view. Therefore, a soldering iron or the like may be inserted from the side of the space, and thus arbitrary alteration of major elements of the high frequency may occur.

### SUMMARY OF THE INVENTION

The present invention is designed to solve the above-described problems, and an object of the invention is to provide an antenna-integrated module capable of easily decreasing the size thereof, preventing arbitrary alternation of a circuit, effectively performing a reflow process, and being manufactured at low cost.

According to an aspect of the invention, there is provided an antenna-integrated module including: a circuit board on which a wiring pattern and a ground conductive layer of a high frequency circuit are disposed; circuit elements which are mounted on one surface of the circuit board; and a sheet-metal covering antenna element which is mounted on the circuit board to cover the circuit elements, wherein the covering antenna element has a top plate which is opposite the circuit board with a predetermined space and serves as a radiation conductor, a power feeding leg piece which extends from a feeding point of the top plate to the circuit board to be connected to the wiring pattern, a short-circuited leg piece which extends from the periphery of one end of the top plate to the circuit board to be connected to the ground conductive layer, a support leg piece which extends from the periphery of the other end of the top plate to the circuit board to be fixed on the circuit board so as to be electrically opened, and side plates which extend at positions other than the power feeding leg piece, the short-circuited leg piece, and the support leg piece from the periphery of the top plate to the circuit board, so that the front ends of the side plates are opposite the circuit board with gaps therebetween, and wherein in the top plate, slit-like or small hole-like openings are formed in a plurality of positions spaced from the periphery of the top plate.

The antenna-integrated module having the above-described configuration can serve as a shield chase for electrically shielding the circuit elements of the high frequency circuit and can also serve as an antenna element of an inverted F-type metal plate antenna by using the top plate as a radiation conductor. Accordingly, it is possible to decrease the size of the entire module and decrease manufacturing cost, compared with a configuration in which a special antenna element and a shield case are disposed in line in plan view. Since the openings are formed at a plurality of positions of the top plate and air can be circulated through the openings, heat can be easily delivered to the region of the circuit board covered with the covering antenna element in the reflow process. Accordingly, the reflow soldering process of the circuit elements mounted on the circuit board and the reflow soldering process of the covering antenna element can be performed together. In addition, since the openings are formed in the slit shape or the small hole shape, it is difficult to inserting a soldering iron or the like into the openings. Since the side plates extend from the periphery of the top plate to the circuit board, it is also difficult to insert the soldering iron or the like into the space covered with the covering antenna element from the side. Therefore, it is difficult to arbitrarily alter the major part of the high frequency circuit of the antenna-integrated module.

In the antenna-integrated module having the above-described configuration, in the side plates, the slit-like or small hole-like openings may be formed at a plurality of positions spaced from the periphery of the side plates. In this case, preferably, heat can be more easily delivered to the region of the circuit board covered with the covering antenna element in the reflow process.

In the antenna-integrated module having the above-described configuration, the top plate may have a rectangular shape, and the short-circuited leg pieces may extend from two positions of one end of the top plate in a longitudinal direction of the top plate and the support leg pieces extend from two positions of the other end of the top plate in the longitudinal direction. In this case, since the shape of the covering antenna element can be simplified, the manufacturing is preferably facilitated. In addition, a third support leg piece having the same shape as the power feeding leg piece may be formed at a position point-symmetrical to the power feeding leg piece, so that the covering antenna element has the symmetrical shape of which the outer appearance is not different even when both ends of the covering antenna element in the longitudinal direction is reversed. In a manufacturing process of mounting the covering antenna element on the circuit board, it is not necessary to check the direction of the antenna element, thereby improving working efficiency.

In the antenna-integrated module having the above-described configuration, the circuit board may be configured to be inserted into or extracted from a connector and the connector has guide pieces which interpose both side portions of the circuit board in a thickness direction of the circuit board, and when the circuit board may be inserted into the connector to be connected to the connector, the guide pieces are located in the gaps extending along a direction of the insertion of the circuit board between the side plates and the circuit board. Since the side plate of the covering antenna element can be prevented from coming in contact with the guide pieces of the connector, the top plate of the covering antenna element can be expanded so as to have the same size as the width size of the circuit board, and moreover the limited space of the circuit board can be effectively used as an element-mounted region. In addition, the top plate may have a rectangular shape, and the short-circuited leg pieces may extend from two positions of one end of the top plate in a transverse direction of the top plate, the support leg pieces extend from two positions of the other end of the top plate in the transverse direction, and the gaps are formed over the entire lengths of the side plates extending from both ends of the top plate in a longitudinal direction of the top plate. Since the shape of the covering antenna element can be simplified, the manufacturing is facilitated. Moreover, it is possible to insert the circuit board into the connector.

In the antenna-integrated module having the above-described configuration, the width sizes of the openings and distances between the front ends of the support leg pieces and the circuit board opposed to each other may be all set to 1 mm or less. It is possible to preferably prevent arbitrary alternation of the major part of the high frequency circuit.

An antenna-integrated module having the above-described configuration can serve as a shield chase for electrically shielding the circuit elements of the high frequency circuit and can also serve as an antenna element of an inverted F-type antenna by using the top plate as a radiation conductor. Accordingly, it is possible to decrease the size of the entire module and decrease manufacturing cost, compared with a configuration in which a special antenna element and a shield case are disposed in line in plan view. Since the openings are formed at a plurality of positions of the top plate and air can be circulated through the openings, heat can be easily delivered to the region of the circuit board covered with the covering antenna element in the reflow process. Accordingly, the reflow soldering process of the circuit elements mounted on the circuit board and the reflow soldering process of the covering antenna element can be performed together. In addition, since the openings are formed in the slit shape or the small hole shape, it is difficult to inserting a soldering iron or the like into the openings. Since the side plates extend from the periphery of the top plate to the circuit board, it is also difficult to insert the soldering iron or the like into the space covered with the covering antenna element from the side. Therefore, it is difficult to arbitrarily alter the major part of the high frequency circuit of the antenna-integrated module.

### BRIEF DESCRIPTION OF THE DRAWINGS

FIG. 1 is a perspective view illustrating an antenna-integrated module according to a first embodiment.

FIG. 2 is an exploded perspective view illustrating a module and a connector shown in FIG. 1.

FIG. 3 is a perspective view illustrating an antenna-integrated module according to a second embodiment.

FIG. 4 is a sectional view illustrating the antenna-integrated module taken along the line IV-IV shown in FIG. 3.

### DESCRIPTION OF THE PREFERRED EMBODIMENT

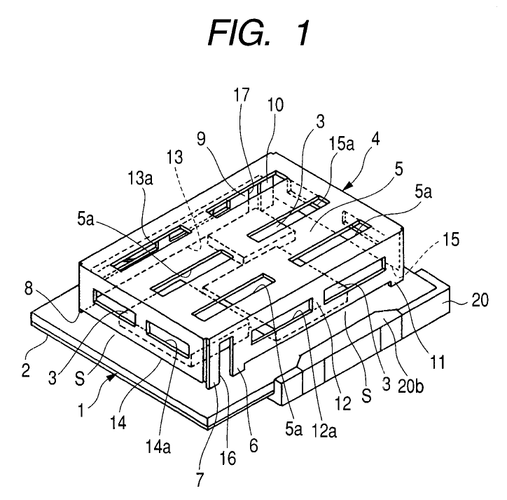

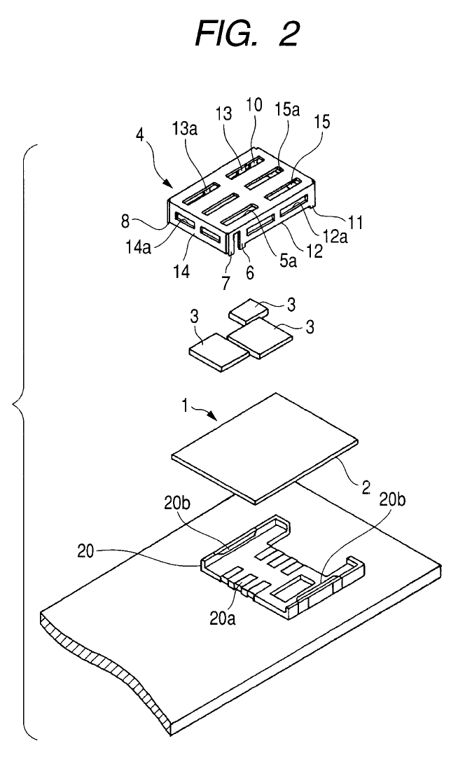

Embodiments of the invention will be described with reference to the drawings. FIG. 1 is a perspective view illustrating an antenna-integrated module according to a first embodiment of the invention. FIG. 2 is an exploded perspective view illustrating a module and a connector shown in FIG. 1.

The antenna-integrated module shown in FIGS. 1 and 2 includes a rectangular circuit board 1 of which the upper surface is provided with a wiring pattern of a high frequency circuit and of which the entire lower surface is provided with a ground conductive layer 2, circuit elements 3 such as a chip element or an IC which are mounted on the upper surface of the circuit board 1 so as to be connected to the wiring pattern, and a sheet-metal covering antenna element 4 which is mounted on the circuit board 1 so as to cover the circuit elements 3. The circuit board 1 is electrically and mechanically connected to a main board 30 with a connector 20 interposed therebetween. The connector 20 includes a plurality of connection terminals 20a disposed on the flat plate portion thereof and a pair of guide pieces 20b that are formed in the side walls erected from both ends of the flat plate portions. The circuit board 1 is regulated in the transverse direction thereof by both the side walls of the connector 20 and is also interposed in the plate-thickness direction thereof by the guide pieces 20b.

The covering antenna element 4 includes a top plate 5 which is a rectangular flat metal plate for covering the circuit elements 3 and serves as a radiation conductor, a power feeding leg piece 6 which extends from the periphery of the top plate 5 to the circuit board 1, short-circuited leg pieces 7 and 8, support leg pieces 9 to 11, and side plates 12 to 15 which extend from the periphery (four sides) of the top plate 5 to the circuit board 1 at positions excluding the pieces 6 to 11. In addition, the power feeding leg piece 6 is connected to the wiring pattern and the short-circuited leg pieces 7 and 8 are connected to the ground conductive layer 2. However, the support leg pieces 9 to 11 are fixed on the circuit board as so to be electrically opened. In addition, slit-like opening portions 5a spaced from the periphery of the top plate 5 are formed at 6 positions of the top plate 5. Slit-like openings 12a to 15a spaced from the periphery are formed at tow positions of each of the side plates 12 to 15.

That is, the side plate 12 along one long side of the top plate 5 is a bent piece of which one end in the longitudinal direction is adjoined with the power feeding leg piece 6 and the other end is adjoined with the support leg piece 11. In the side plate 12, the openings 12a extending along the long side of the top plate 5 are formed at two positions in line and a short-circuited leg piece 7 is formed at a position adjacent through the power feeding leg piece 6 and a notched portion 16. Likewise, the side plate 13 along the other long side of the top plate 5 is a bent piece of which one end in the longitudinal direction is adjoined with the power feeding leg piece 8 and the other end is adjoined to the support leg piece 9. In the side plate 13, the openings 13a extending along the long side of the top plate 5 are formed at two positions in line and the support leg piece 10 is formed at a position adjacent the support leg piece 9 with a notched portion 17 interposed therebetween. In the side plate 14 extending along one entire short side of the top plate 5, the openings 14a extending along the short side are formed in line at two positions. Likewise, in the side plate 15 extending along the other entire short side of the top plate 5, the openings 15a extending along the short side are formed in line at two positions. The width size (slit width) of the slit-like openings 12a to 15a formed in the side plate 12 to 15 is configured to be 1 mm or less. In addition, gaps S are interposed in the ends (lower end portions) of the side plates 12 to 15 so as to be opposed to the circuit board 1 and the size of the opposed gaps is 1 mm or less.

The pieces 6 to 11 of the covering antenna element 4 will be described in detail. The lower portion of the power feeding leg piece 6 is connected to a feeding line of the wiring pattern and a predetermined high frequency signal is configured to be supplied to a feeding point (the upper end of the bent portion of the power feeding leg piece 6) of the top plate 5 through the power feeding leg piece 6. The short-circuited leg pieces 7 and 8 are connected to the ground conductive layer 2 through a through-hole of the circuit board 1. All the support leg pieces 9 to 11 are connected to an electrically isolated soldering land of the circuit board 1. Electrostatic capacitance is loaded between the soldering land and the ground conductive layer 2. That is, the covering antenna element 4 is stably mounted on the circuit board 1 by soldering the pieces 6 to 11 to land to the corresponding soldering land and the top plate 5 is opposite the circuit board 1 at a predetermined interval. As shown in FIG. 4, the short-circuited leg piece 7 and 8 and the support leg pieces 10 and 11 are formed in four corners of the covering antenna element 4. Moreover, the support leg piece 9 of which the shape is the same as that of the power feeding leg piece 6 is formed at a point-symmetrical position in which the support leg piece 9 is point-symmetrical to the power feeding leg piece 6. Accordingly, even through both ends in the longitudinal direction is reversed, a symmetrical structure of which the outer appearance is not different can be designed.

In the antenna-integrated module configured in the manner, the sheet-metal covering antenna element 4 which covers the circuit elements 3 is connected to the ground conductive layer 2. Therefore, the covering antenna element 4 can serve as a shield case. In the rectangular top plate 5 of the covering antenna element 4, one end portion thereof in the longitudinal direction is provided with the short-circuited leg pieces 7 and 8 and the other end portion is electrically opened and the top plate 5 is excited by the feeding operation from the power feeding leg piece 6. Accordingly, the top plate 5 can serve as a radiation conductor of an inverted F-type sheet-metal antenna.

That is, in the antenna-integrated module according to this embodiment of the invention, the covering antenna element 4 that covers the major part of the high frequency circuit not only serves as the shield cover, but also serves as an antenna element of the inverted F-type antenna. Accordingly, it is possible to decrease the size thereof and achieve low cost, compared with a structure in which a special antenna element and a shield case are disposed in line in plan view. Moreover, the covering antenna element 4 is designed so that the support leg pieces 9 to 11 are electrically opened, that is, the electrostatic capacitance is loaded on portions which become an electric field region at the feeding time. Accordingly, it is possible to further decrease the size of the module.

In the antenna-integrated module, the plurality of openings 5a and the plurality of openings 12a to 15a are formed in the top plate 5 of the covering antenna element 4 and the side plates 12 to 15, respectively, and moreover air can be smoothly circulated through the openings 5a and 12a to 15a. Accordingly, in a reflow process, heat can be delivered to the region of the circuit board 1 covered with the covering antenna element 4, and thus a reflow soldering of the circuit elements 3 mounted on the circuit substrate 1 and a reflow soldering of the covering antenna element 4 can be performed together. That is, since the reflow process does not need repeatedly, it is possible to manufacture the antenna-integrated module.

In the antenna-integrated module, the side plates 12 to 15 extend from the periphery of the top plate 5 to the circuit board 1 and the distance (gap S) between the end of each of the side plates 12 to 15 and the circuit board 1 opposed to each other is configured to be 1 mm or less. Accordingly, it is difficult to inserting a soldering iron or the like into the space covered with the covering antenna element 4 from the side. Moreover, since the width of the slit-like openings 5a and 12a to 15a are configured to be 1 mm or less, it is difficult to inserting the soldering iron or the like into the openings 5a and 12a to 15a. As a result, it is difficult to arbitrarily alternate the major elements of the high frequency circuit of the antenna-integrated module.

Since the shape of the sheet-metal covering antenna element 4 is simple, it is easy to manufacture the antenna-integrated module according to the embodiment of the invention. Moreover, the covering antenna element 4 has a point-symmetrical structure. Accordingly, even thought both ends of the covering antenna element 4 in the longitudinal direction are reversed, the outer appearance is not different. For this reason, in a manufacturing process of mounting the covering antenna element 4 on the circuit board 1, it is not necessary to check the direction of the covering antenna element 4, thereby improving the working efficiency.

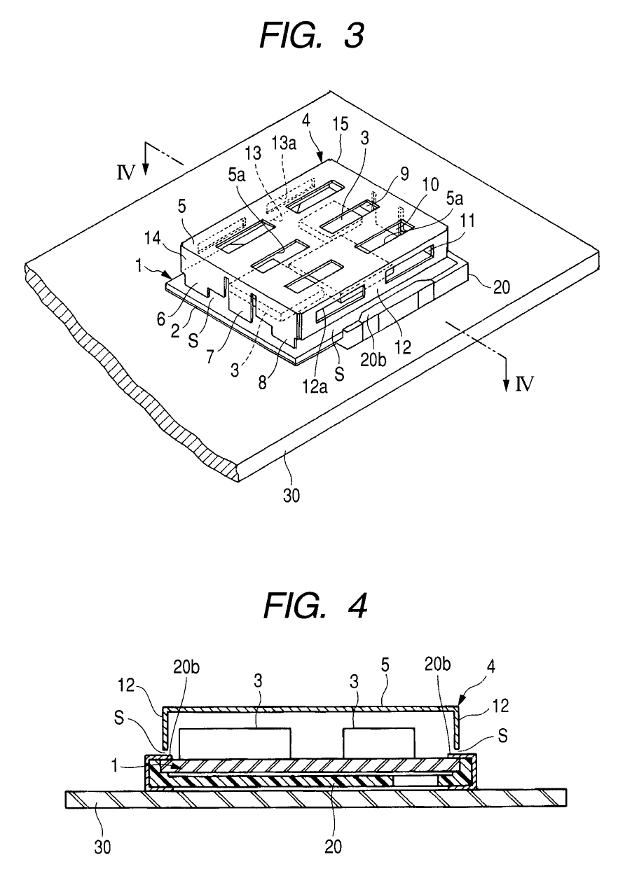

FIG. 3 is a perspective view illustrating an antenna-integrated module according to a second embodiment of the invention. FIG. 4 is a sectional view illustrating the antenna-integrated module taken along the line IV-IV line shown in FIG. 3. In addition, the same reference numerals are given to the same elements corresponding to those in FIGS. 1 and 2.

The second embodiment of the invention is different from the first embodiment described above in that a circuit board 1 of a top plate 5 has a squire with the substantially same width and a power feeding leg piece 6, short-circuited leg pieces 7 and 8, support leg pieces 9 to 11 extending from the top plate 5 are formed at different positions. In addition, other configuration and operational effect are basically the same. That is, a side plate 14 along one short side of the top plate 5 is a bent piece of which one end portion in the transverse direction thereof is adjoined with the power feeding leg piece 6, a center portion is adjoined with the short-circuited leg piece 7, and the other end is adjoined with the short-circuited leg piece 8. Likewise, a side plate 15 along the other short side of the top plate 5 is a bent piece of which one end portion, a center portion, and the other end portion are adjoined with the support leg pieces 9, 10, and 11, respectively. In addition, in a side plate 12 extending over one entire long side of the top plate 5, openings 12a extending along the long side are formed in line at two positions. Likewise, in a side plate 13 extending along the other entire long side of the top plate 5, openings 13a extending along the other long side are formed in line at two positions. The front ends of the side plates 12 to 15 are opposite the circuit board 1 with gaps S interposed therebetween. Moreover, in both the side plates 12 and 13 over the long sides of the top plate 5, the gaps S are formed from end to end in the longitudinal direction thereof.

In the antenna-integrated module configured in this manner, the circuit board 1 is interested below both guide pieces 20b of a connector 20 so that the circuit board 1 is electrically and mechanically connected to a main board 30 through the connector 20. At this time, the circuit board 1 is fixed so as not to be detached from the connector 20 by both the guide pieces 20b. As shown in FIG. 4, these guide pieces 20b are positioned in the gaps S formed between the side plate 12 and the circuit board 1 and between the side plate 13 and the circuit board 1. That is, when both side portions of the circuit board 1 are inserted into the lower portions of the guide pieces 20b of the circuit board 1 to be connected to the connector 20, the guide pieces 20b pass through the gaps S which are formed below the side plates 12 and 13 and extend along the insertion direction of the circuit board 1. Accordingly, it is possible to avoid contact between the guide pieces 20b and the side plates 12 and 13 by the gaps S. Therefore, since the top plate 5 of the covering antenna element 4 can be expanded so as to be the same as the width size of the circuit board 1, a limited region of the circuit board 1 can be effectively used as an element-mounted region. Moreover, the broad region of the top plate 5 can be used as an attachment surface of a label (not shown).

In the above-described embodiments, the opening 5a of the top plate 5 extends along the longitudinal direction. However, the opening 5a may extend along the transverse direction. In addition, the opening 5a or the openings 12a to 15a may be shaped in a small hole instead of the slit shape. In this case, it is possible to avoid the repetition reflow process by punching various small holes.

1. An antenna-integrated module comprising:
a circuit board on which a wiring pattern and a ground conductive layer of a high frequency circuit are disposed;
circuit elements which are mounted on one surface of the circuit board; and
a sheet-metal covering antenna element which is mounted on the circuit board to cover the circuit elements,
wherein the covering antenna element has a top plate which is opposite the circuit board with a predetermined space and serves as a radiation conductor, a power feeding leg piece which extends from a feeding point of the top plate to the circuit board to be connected to the wiring pattern, a short-circuited leg piece which extends from the periphery of one end of the top plate to the circuit board to be connected to the ground conductive layer, a support leg piece which extends from the periphery of the other end of the top plate to the circuit board to be fixed on the circuit board so as to be electrically opened, and side plates which extend at positions other than the power feeding leg piece, the short-circuited leg piece, and the support leg piece from the periphery of the top plate to the circuit board, so that the front ends of the side plates are opposite the circuit board with gaps therebetween, and
wherein in the top plate, slit-like or small hole-like openings are formed in a plurality of positions spaced from the periphery of the top plate.

2. The antenna-integrated module according to claim 1, wherein in the side plates, the slit-like or small hole-like openings are formed at a plurality of positions spaced from the periphery of the side plates.

3. The antenna-integrated module according to claim 1, wherein the top plate has a rectangular shape, and
wherein the short-circuited leg pieces extend from two positions of one end of the top plate in a longitudinal direction of the top plate and the support leg pieces extend from two positions of the other end of the top plate in the longitudinal direction.

4. The antenna-integrated module according to claim 3, wherein a third support leg piece having the same shape as the power feeding leg piece is formed at a position point-symmetrical to the power feeding leg piece, so that the covering antenna element has the symmetrical shape of which the outer appearance is not different even when both ends of the covering antenna element in the longitudinal direction is reversed.

5. The antenna-integrated module according to claim 1, wherein the circuit board is configured to be inserted into or extracted from a connector and the connector has guide pieces which interpose both side portions of the circuit board in a thickness direction of the circuit board, and
wherein when the circuit board is inserted into the connector to be connected to the connector, the guide pieces are located in the gaps extending along a direction of the insertion of the circuit board between the side plates and the circuit board.

6. The antenna-integrated module according to claim 5, wherein the top plate has a rectangular shape, and
wherein the short-circuited leg pieces extend from two positions of one end of the top plate in a transverse direction of the top plate, the support leg pieces extend from two positions of the other end of the top plate in the transverse direction, and the gaps are formed over the entire lengths of the side plates extending from both ends of the top plate in a longitudinal direction of the top plate.

7. The antenna-integrated module according to claim 1, wherein the width sizes of the openings and distances between the front ends of the support leg pieces and the circuit board opposed to each other are all set to 1 mm or less.
